(19) United States
(12) Patent Application Publication
(10) Pub. No.: US 2004/0202695 A1
(43) Pub. Date: Oct. 14, 2004

(54) Nutritional supplement for post rumen metabolism

(75) Inventor: William P. Moore, Hopewell, VA (US)

Correspondence Address: William P. Moore, P. O. Box 1270, Hopewell, VA, 23860, US

(73) Assignee: Agri-Nutrients Technology Group, Inc.

(21) Appl. No.: 10/410,694

(22) Filed: Apr. 11, 2003

(51) Int. Cl. A23K 1/165

(52) U.S. Cl. 424/442; 426/53; 426/460

(57) ABSTRACT

A nutritional feed supplement composition for post rumen metabolism in ruminant animals composed of spheroid nutrient particles coatingly covered with divalent metal salts which are insoluble in near-neutral rumen fluid but soluble in acidic post rumen digestive fluids. The composition protects nutrients which would be of no value if exposed to rumen fluids but are beneficial when available for metabolism in post rumen digestive fluids. The nutrients may be dispersed in inert powders formed into spheroid particles, and the divalent metal salts may be dispersed in a resin membrane insoluble in all ruminant fluids. Nutrient particles in the composition include enzymes, amino acids, vitamins, single cell proteins, and medicinal materials. The divalent metal salts include magnesium phosphate, magnesium ammonium phosphate, and magnesium stearate. The resin membranes include polyurethane, polyethylene and polyacrylonitrile-butadiene-styrene. The inert powders include diatomaceous earth, feathermeal, and grain flours.

### BACKGROUND OF THE INVENTION

1. Field of the Invention

The present invention relates to animal nutrition and more particularly to a nutritional supplement which is protected from absorption in the rumen for post rumen metabolism by ruminant animals. Still more particularly, it relates to a composition of closely sized spheroid particles of nutrients, such as amino acids and vitamins, coatingly covered by divalent metal salts, such as magnesium phosphate or calcium stearate, which are insoluble in near-neutral rumen fluid, but soluble in acidic post rumen digestive fluids. The nutrients may be diluted by dispersing in an inert powder, such as diatomaceous earth, which may be formed into spheroid particles. The divalent metal salts may be dispersed throughout a resin membrane such as polyurethane, insoluble in ruminant digestive fluids, coatingly covering the spheroid nutrient particles.

2. Description of Prior Art

Many nutritionally valuable ruminant feed supplements are degraded as they pass through the rumen at near-neutral pH and are therefore of little, or no, value to the animal. However, if these feed supplements were delivered without degradation to the acidic post rumen digestive fluids, they could be metabolized as valuable nutrients. These nutritionally valuable feed supplements include: highly concentrated nutrients such as amino acids, milk replacer, single cell, and fungi; and small amounts of animal health enhancers such as vitamins, choline, and minor elements.

Workers in the prior art have improved the delivery of nutritional materials by coating them. In U.S. Pat. No. 4,876,097 Autant et al disclosed a composition for coating a biologically active material which is stable at pHs of 5 or greater, but permits release at pH of 3.5, or less. The coating is a complicated mixture of at least three materials containing cellulose derivatives, polyols, and polymers of amino derivatives of acrylic acid, methacrylic acid, vinyl pyridine, styrene, and chitosan. Autant et al disclosed that microcapsules protected by this coating composition are particularly useful with the amino acids lysine and methionine.

Anderson in U.S. Pat. No. 5,885,610 furthered the controlled release nutrient art by feeding calcium or magnesium salts of amino acids which are resistant to degradation by bacterial microbes in the rumen and are beneficial to ruminants after reaching the abomasum and the intestines. The compounds comprise calcium and/or magnesium amino acid salts in a 1:1 or 1:2 metal to acid mol ratio. Thus, requiring the use of large amounts of unnecessary dilution with elements such as calcium and magnesium.

Annonier et al in U.S. Pat. No. 6,306,427 disclosed controlled release pellets containing active ingredients protected against degradation by using binders which are used in solvents, or are capable of being melted.

The controlled release is effected by the dissolution of the binder in the acidic abomasum or intestines after passing through the rumen. The binders used are similar to coating materials of Autant et al, U.S. Pat. No. 4,876,097. Binders must be distributed throughout the large pellet to achieve protection through the rumen for release in the abomasum and intestines, thus adding large amounts of usually unwanted materials to the product.

Rode et al in U.S. Pat. No. 5,871,773 provide a method of supplementing amino acid levels in ruminant animals by combining a rumen-protected lysine and/or methionine with a standard animal feed, wherein a lysine and/or methionine core composition is protected with a coating of lecithin, at least one inorganic substance which is stable in neutrality, and soluble in acidic conditions, and at least one substance selected from saturated or unsaturated monocarboxylic C₁₄-C₂₂ acids, salts thereof, and hardened vegetable oil, and the like. The coatings are complicated, costly, and difficult to work with in practical operations.

Thus, the prior art has provided coated nutrients which pass through the rumen for metabolism in the abomasum and small intestines, but these prior art nutrients are either complicated, costly, or require the use of large amounts of non-metabolizable materials.

### OBJECTS OF THE INVENTION

Therefore, it is an object of this invention to provide an effective nutritional supplement composition for post rumen metabolism in ruminant animals which is simple, inexpensive and contains little, or no, non-metabolizable materials.

It is another object to provide a nutritional supplement composition in which particulate nutrients are protected from degradation in rumen fluids by a thin coating amounting to a minor portion of the composition.

It is another object to provide a compositon wherein a minor amount of inorganic coating covering the nutrients protects the nutrients through the rumen and is then metabolized along with the nutrients in the abomasum and intestines of the ruminant animals.

It is another object to provide a composition wherein the particulate nutrients and the inorganic material coatingly covering the nutrients are diluted with inert materials as desired for reasons of composition utility and economics.

### SUMMARY OF THE INVENTION

I have now discovered a particulate nutritional supplement composition for ruminant animals which is prepared from agricultural commodity components. It passes through near-neutral rumen digestive fluids without degradation for effective metabolism in the acidic post rumen digestive fluids.

The new composition comprises spheroid nutrient particles coatingly covered with divalent metal salts which are insoluble in near-neutral rumen fluids but soluble in acidic post rumen digestive fluids. The nutrient particles may be diluted by dispersion in inert powders formed into spheroid granules, and the divalent metal salts may be diluted by dispersion through a resin membrane coatingly covering the spheroid granules. The effective nutrients in this new composition include: amino acids, single cell proteins, milk replacer, vitamins, fungi, and enzymes. The effective divalent metal salts include: magnesium phosphate, magnesium stearate, magnesium silicate, magnesium maleate, magnesium succinate, magnesium pyrophosphate, magnesium ammonium phosphate, and magnesium salts of mixed fatty acids. Calcium salts of the foregoing acid ions are also effective.

The term “coatingly covering” means that the particle is coated so that there is no uncovered surface on the particle and liquid may penetrate the coating primarily by osmosis.

### DETAILED DESCRIPTION OF THE INVENTION

The present invention is a nutritional feed supplement composition for post rumen metabolism in ruminant animals which comprises spheroid nutrient particles exhibiting diameters between 0.2 and 3.0 millimeters. Smaller particles are difficult to accurately coat and larger particles may be chewed by the ruminant physically destroying the coatings. The spheroid nutrient particles are beneficial to ruminant animals by metabolism in post rumen digestive fluids, but provide little, or no, nutritional value if absorbed in the rumen fluid.

The effective composition includes one, or more, divalent metal salts which are insoluble in near-neutral rumen fluids, but soluble in acidic post rumen digestive fluids, coatingly covering the spheroid nutrient particles and amounting to between 1 and 20 percent of the composition. When less than 1 percent coating is included in the composition the protection provided in the rumen fluid is inadequate to prevent degradation of the nutrients in the rumen. Compositions containing more than 20 percent coating provide more acid ions than are effectively used in the post rumen fluids.

The nutritional supplement composition is particularly useful where the spheroid nutrient particles comprise comestible materials which would be substantially degraded without benefit to the ruminant animal if released in rumen fluid.

The nutritional supplement of this invention is useful where the spheroid nutrient particles consist of enzymes, amino acids, vitamins, fungi, single cell , medicinal supplements and minor elements. Some specific examples of this type of nutritional supplement include the enzyme phytase, amino acids lysine and methionine, vitamins A, C, and D, fungi such as torula yeast, fermented single cell, and minor elements such as zinc, manganese, copper, and iron.

Although the nutritional supplement composition of this invention may be varied somewhat so long as the foregoing basic premises are followed, utilization of the nutritional materials is best achieved where the spheroid nutrient particles comprise between 70 and 99 percent of the composition. Economics of the composition are impaired when less than 70 percent nutrient particles are included. When more than 99 percent nutrient particles are included, the coating does not provide sufficient protection in the rumen fluid.

The divalent metal salts of the nutritional supplement are preferably salts of the divalent metals magnesium, calcium, and iron.

The anions of the divalent metal salts are preferably anions which produce salts insoluble in rumen fluids, including phosphates, stearates, maleates, succinates, silicates, pyrophosphates, and mixed fatty acids.

The divalent metal salts coatingly covering the spheroid nutrient particles may be applied by normal means, such as spraying on, or by rolling damp nutrient particles in powdered salts. The composition is preferably prepared where the rumen insoluble divalent metal salts coatingly covering the spheroid nutrient particles are formed in-situ on the spheroid nutrient particles by reaction of soluble divalent metal compounds with soluble salt-forming acid.

The nutritional supplement for post rumen metabolism in ruminal animals is effective and preferred when particulate nutrients beneficial to ruminant animals by metabolism in post rumen digestive fluids but which provide little, or no, benefits when absorbed in rumen fluid, amounting to between 0.1 and 75 percent of the composition are dispersed in inert powder amounting to between 10 and 95 percent of the composition. It is preferred that the inert powder be formed into spheroid granules exhibiting diameters between 0.3 and 2.0 millimeters. The preferred composition contains one, or more, divalent metal salts which are insoluble in near-neutral rumen fluid, but soluble in acidic post rumen digestive fluids. The divalent metal salts coatingly cover the spheroid granules preferably in amounts between 1 and 20 percent of the composition.

The inert powders in which the particulate nutrients may be dispersed are materials which are not harmful to ruminants, which are readily miscible with the nutrients, and which readily form spheroid particles that may be effectively coated with divalent salts. Inert powders particularly effective in the composition of this invention are diatomaceous earth, bentonite, grain flours, kaolin, feathermeal, wheat middlings, and dried molasses.

The divalent salts coatingly covering the particulate nutrients are the materials which control the access to the nutrients by the rumen fluid and/or the post rumen fluids. These salts may be used in pure form or may be diluted with other inert and impervious materials. A particularly effective nutritional supplement composition is obtained where the one, or more, divalent metal salts, which are insoluble in near-neutral rumen digestive fluid but soluble in acidic post rumen digestive fluids, are finely divided particles amounting to between 1 and 5 percent of the total composition dispersed throughout a resin membrane which is insoluble in all ruminant digestive fluids, coatingly covering the spheroid nutrient granules in amounts between 3 and 20 percent of the composition.

A variety of resin membranes may be used. Particularly effective nutritional supplement compositions are those where the resin membranes insoluble in all ruminant digestive fluids are polyurethane, polyethylene, polypropylene, polyalkyd, polycarbonate, and polyacrylonitrile-butadiene-styrene.

The nutritional supplement composition is most useful where the nutrients beneficial to ruminant animals by metabolism in post rumen digestive fluids are one of the following valuable nutrients: amino acids, single cell, milk replacer, vitamins, fungi, and enzymes.

The nutrients may be biologically active substances which are effective in enhancing the health of the ruminant animal when released in the post ruminal digestive fluids.

Nutritional supplement compositions are particularly effective where the divalent metal salts consist of magnesium phosphate, magnesium stearate, magnesium maleate, magnesium succinate, magnesium pyrophosphate, magnesium ammonium phosphate, and magnesium salt of mixed fatty acids.

A particularly effective nutritional supplement composition for post rumen metabolism in ruminant animals is obtained by close control of the composition components and their concentrations. In this composition, nutrients consist of one, or more, of the following: amino acids, single cell proteins, milk replacer, vitamins, fungi, and enzymes. These nutrients amounting to between 30 and 75 percent of the composition are dispersed in inert powders listed as follows: diatomaceous earth, bentonite, grain flour, kaolin, and dried molasses. The inert powder amounting to between 5 and 50 percent are formed into spheroid granules exhibiting diameters between 0.5 and 1.5 millimeters. Divalent metal salts consisting of magnesium phosphate, magnesium stearate, magnesium pyrophosphate, magnesium ammonium phosphate, magnesium maleate, magnesium succinate, or a magnesium salt of mixed fatty acids, amounting to between 1 and 10 percent of the composition are dispersed throughout a resin membrane coatingly covering the spheroid granules. The resin membrane consists of polyurethane, polyethylene, polypropylene, polyalkyd, polycarbonate, or polyacrylonitrile-butadiene-styrene amounting to between 3 and 20 percent of the composition.

The nutritional supplement composition of this invention is effective when it is prepared by the following stepwise method. Nutrients amounting to between 30 and 75 percent of the composition are dispersed in inert powder amounting to between 5 and 50 percent of the composition to form a particulate mixture. The particulate mixture is then formed into spheroid granules exhibiting diameters between 0.2 and 3.0 millimeters.

Divalent metal salts amounting to between 1 and 10 percent of the composition are dispersed into liquid resin amounting to between 3 and 20 percent of the composition with the divalent metal salts exhibiting insolubility in near-neutral rumen fluid, but solubility in acidic post rumen digestive fluids.

The spheroid granules are then coatingly covered with a membrane consisting of the divalent metal salts dispersed in the liquid resin. The liquid resin is then cured so that it is insoluble in all ruminant digestive fluids. The liquid resins used can be selected from one or more of the following: polyurethane, polyethylene, polypropylene, polyalkyd, polycarbonate, and polyacrylonitrile-butadiene-styrene.

The nutritional supplement composition is even more effective when prepared by the foregoing method where the liquid resins into which the divalent metal salts are dispersed, applied and cured is in a plurality of layers. This application allows effective sealing of the covering on the granules while using a minimum of coating resin.

### MODE OF OPERATION OF THE INVENTION

The preferred embodiment of this invention is illustrated by the following examples which are provided for the purpose of illustration and are not to be regarded as limiting the scope of the invention or the manner in which it can be practiced.

### EXAMPLE 1

This example is provided to illustrate the preparation of the nutritional feed supplement composition of this invention for post rumen metabolism in ruminant animals and the efficacy of the composition.

A microbially formed lipoprotein was hydrolyzed and dried to form a nutrient comprising 83 percent mixed amino acids. The mixed amino acid was granulated to form spheroid granules exhibiting a mean particle diameter of 1.2 millimeters.

The spheroid granules were placed in a rolling coating drum. Concentrated phosphoric acid amounting to about 1 percent was sprayed on the rolling granules and then an equi-molar amount of fine magnesium oxide was added slowly to the rolling granules, reacting with the phosphoric acid on the surface of the granules to form magnesium phosphate. These cycles were repeated until the surface was coatingly covered with divalent metal salt. The granules were then dried in-situ. The coated nutritional feed supplement granules were analyzed as follows:

| Component | Wt % |
|---|---|
| Mixed Amino Acids | 70.1 |
| Other materials in the amino acids | 14.8 |
| Magnesium Phosphate | 15.1 |

The efficacy of the granules was determined by measuring the generation of ammonia in rumen fluid in in-vitro tests at a near neutral pH of 6.3 for 16 hours. The pH of the digestive fluid was then adjusted to 2.0 by addition of 0.1 N HCl, and ammonia concentrations were measured again for an additional 2 hours to assay the availability of the amino acids in post rumen acidic digestive fluids. The analyses obtained are tabulated in Table 1:

TABLE 1

| NH₃—N Conc. in Rumen Fluid | | | | | NH₃—N Conc. in Digestive Fluid | | |
|---|---|---|---|---|---|---|---|
| at pH 1 6.6 as a function of hold time, | | | | | at pH 2.0, as a function of | | |
| Wt % | | | | | time, Wt % | | |
| 1 hr | 2 hr | 4 hr | 8 hr | 24 hr | 15 min | 30 min | 2 hr |
| 0.0200 | 0.0120 | 0.0100 | 0.0200 | 0.0320 | 0.0800 | 0.1800 | 0.2800 |

It may be seen from the foregoing data that very little of the amino acid was released in the near-neutral rumen fluid and that most of the nitrogen was released quickly in the acidic digestive fluid in thirty minutes.

### EXAMPLE 2

This example is provided to illustrate the preparation of an economical nutritional feed supplement composition using inert diluted nutrients, and divalent metal salts dispersed in a resin membrane insoluble in all digestive fluids to coatingly cover the nutrients.

In a rolling mixer the enzyme phytase was mixed with diatomaceous earth to form a homogeneous mixture which was then formed into particles approaching the shape of spheroids. The spheroid composition contained 5 percent by weight phytase, 93 percent diatomaceous earth, and 2 percent moisture. The spheroids were screened to retain particles having diameters more than 0.2 and less than 3.0 millimeters.

The spheroids were placed in a rolling coater and sprayed with layers of aqueous polyurethane resin dispersion. The dispersion contained 31 percent by weight polyurethane resin and 10 percent by weight magnesium ammonium phosphate powder. The spray coating was applied onto granules at 70° C. and after each application of about 1 percent of the spheroid's weight, vacuum was applied to dry the coating. The coating layers were continued until the coating amounted to 5.7 percent by weight on the dry spheroid. Analyses of the coated spheroid were as follows:

| Component | Wt % |
|---|---|
| Phytase | 4.8 |
| Diatomaceous Earth | 88.4 |
| Magnesium Ammonium Phosphate | 1.4 |
| Polyurethane Membrane | 4.3 |
| Moisture | 1.1 |

The foregoing composition was placed in rumen fluid at pH 6.6 withdrawn from the rumen of a fistulated steer, and soaked for 8 hours, and withdrawn. Microscopic inspection of the coated spheroids showed that the coatings were intact and that the phytase was still in the spheroids. The pH of the rumen digestive fluid was reduced to 2.0 by addition of dilute HCl and the spheroids were soaked for periods of 15, 30, and 120 minutes. Microscopic inspection of these spheroids indicated that the magnesium ammonium phosphate divalent metal salt particles were largely dissolved after 15 minutes and completely gone after 2 hours. Thus, the phytase was released in a timely manner in the acidic post rumen digestive fluids after being protected from destruction in the near neutral rumen fluids.

I claim:

1. A nutritional feed supplement composition for post rumen metabolism in ruminant animals, comprising:
(a) spheroid nutrient particles, exhibiting diameters between 0.2 and 3.0 millimeters, beneficial to ruminant animals by metabolism in post rumen digestive fluids, but providing little, or no, nutrition if absorbed in the rumen fluid; and,
(b) one, or more, divalent metal salts which are insoluble in near-neutral rumen fluid, but soluble in acidic post rumen digestive fluids, coatingly covering the spheroid nutrient particles and amounting to between 1 and 20 percent of the composition.

2. The nutritional supplement composition of claim 1 wherein the spheroid nutrient particles comprise comestible materials which would be substantially degraded without benefit to the ruminant animal if released in rumen fluid.

3. The nutritional supplement composition of claim 1 wherein the spherical nutrient particles are selected from the group consisting of enzymes, vitamins, fungi, amino acids, single cell proteins, medicinal materials and minor elements.

4. The nutritional supplement composition of claim 1 wherein the spheroid nutrient particles comprise between 70 and 99 percent of the composition.

5. The nutritional supplement composition of claim 1 wherein the divalent metals of the salts are selected from the group of divalent metals consisting of magnesium, calcium, and iron.

6. The nutritional supplement composition of claim 1 wherein the anions of the divalent metal salts are anions which produce salts insoluble in rumen fluids selected from the group consisting of phosphates, stearates, maleates, succinates, silicates, pyrophosphates, and mixed fatty acids.

7. The nutritional supplement composition of claim 1 wherein the rumen insoluble divalent metal salts coatingly covering the spheroid nutrient particles are formed in-situ on the spheroid nutrient particles by reaction of soluble divalent metal compounds with soluble salt-forming acids.

8. A nutritional supplement composition for post rumen metabolism in ruminant animals, comprising:
(a) particulate nutrients beneficial to ruminant animals by metabolism in post rumen digestive fluids but providing little, or no, benefits when absorbed in rumen fluid, amounting to between 0.1 and 75.0 percent of the composition, dispersed in inert powder amounting to between 10 and 95 percent of the composition, the inert powder formed into spheroid granules exhibiting diameters between 0.3 and 2.0 millimeters; and,
(b) one, or more, divalent metal salts which are insoluble in near-neutral rumen fluid, but soluble in acidic post rumen digestive fluids, the divalent metal salts coatingly covering the spheroid granules in amounts between 1 and 20 percent of the composition.

9. The nutritional supplement composition of claim 8 wherein the inert powder is selected from the group consisting of diatomaceous earth, bentonite, grain flours, kaolin, feathermeal, wheat middlings and dried molasses.

10. The nutritional supplement composition of claim 8 wherein the one, or more, divalent metal salts, which are insoluble in near-neutral rumen digestive fluids but soluble in acidic post rumen digestive fluids, comprise finely divided particles, amounting to between 1 and 5 percent of the composition, dispersed throughout a resin membrane insoluble in all ruminant digestive fluids coatingly covering the spheroid nutrient granules in amounts between 3 and 20 percent of the composition.

11. The nutritional supplement composition of claim 10 wherein the resin membrane insoluble in all ruminant digestive fluids, is selected from the group of resins consisting of polyurethane, polyethylene, polypropylene, polyalkyd, polycarbonate, and polyacrylonitrile-butadiene-styrene.

12. The nutritional supplement composition of claim 10 wherein the nutrients beneficial to ruminant animals by metabolism in post rumen digestive fluids are selected from the group consisting of amino acids, single cell proteins, milk replacer, vitamins, fungi, and enzymes.

13. The nutritional supplement composition of claim 10 wherein the nutrients comprise biologically active substances effective in enhancing the health of ruminant animals when released in post ruminal digestive fluids.

14. The nutritional supplement composition of claim 10 wherein the divalent metal salts are selected from the group consisting of magnesium phosphate, magnesium stearate, magnesium maleate, magnesium succinate, magnesium pyrophosphate, magnesium ammonium phosphate, and magnesium salt of mixed fatty acids.

15. A nutritional supplement composition for post rumen metabolism in ruminant animals, comprising:
(a) nutrients consisting of one or more of the group consisting of amino acids, single cell proteins, milk replacer, vitamins, fungi, and enzymes amounting to between 30 and 75 percent of the composition, dispersed in inert powders selected from the group consisting of diatomaceous earth, bentonite, grain flour, kaolin, and dried molasses amounting to between 5 and 50 percent of the composition, the inert powders formed into spheroid granules exhibiting diameters between 0.5 and 1.5 millimeters; and,
(b) divalent metal salts selected from the group consisting of magnesium phosphate, magnesium stearate, magnesium maleate, magnesium succinate, magnesium pyrophosphate, magnesium ammonium phosphate, and a magnesium salt of mixed fatty acids, amounting to between 1 and 10 percent of the composition, the divalent metal salts dispersed throughout a resin membrane coatingly covering the spheroid granules, the resin membrane selected from the group consisting of polyurethane, polyethylene, polypropylene, polyalkyd, polycarbonate, and polyacrylonitrile-butadiene-styrene, amounting to between 3 and 20 percent of the composition.

16. The nutritional supplement composition of claim 15 prepared by the stepwise method comprising:
(a) dispersing nutrients amounting to between 30 and 75 percent of the composition in inert powders amounting to between 5 and 50 percent of the composition to form a particulate mixture;
(b) forming the particulate mixture into spheroid granules exhibiting diameters between 0.2 and 3.0 millimeters;
(c) dispersing divalent metal salts amounting to between 1 and 10 percent of the composition into liquid resin amounting to between 3 and 20 percent of the composition, the divalent metal salts exhibiting insolubility in near-neutral rumen fluid but solubility in acidic post rumen digestive fluids;
(d) coatingly covering the spheroid granules with a membrane consisting of the divalent metal salts dispersed in the liquid resin; and,
(e) curing the liquid resin so that it is insoluble in all ruminant digestive fluids, the liquid resins being selected from the group consisting of polyurethane, polyethylene, polypropylene, polyalkyd, polycarbonate, and polyacrylonitrile-butadiene-styrene.

17. The nutritional supplement composition prepared by the method of claim 16 wherein the liquid resins into which the divalent salts are dispersed, applied and cured is in a plurality of layers.
